(19) United States
(12) Patent Application Publication
(10) Pub. No.: US 2009/0185202 A1
(43) Pub. Date: Jul. 23, 2009

(54) METHODS AND SYSTEMS FOR SELECTING PRINTING MATERIALS

(75) Inventors: Javier A. Morales, Irondequoit, NY (US); Nicholas Paul Osadciw, Webster, NY (US); Michael E. Farrell, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/016,362

(22) Filed: Jan. 18, 2008

(51) Int. Cl. G06F 15/00; H04N 1/60; G06F 3/12

(52) U.S. Cl. 358/1.9; 358/1.15

(57) ABSTRACT

Methods and systems for selecting printing materials are disclosed. One or more performance criteria and a print job may be received. At least one performance criterion may be used to measure a capability for a plurality of sets of printing materials. A computing device may evaluate the print job with respect to the one or more performance criteria in order to produce evaluation information. A first set of printing materials may be selected from the plurality of sets of printing materials based on the evaluation information. An indication of the first set of printing materials may be provided.

### BACKGROUND

The present disclosure generally relates to color print systems and methods for operating such systems. More specifically, the present disclosure relates to methods and systems for determining printing materials that are best suited to printing a print job.

Conventionally, print operations printing a full range of colors have been performed using printing materials having four colors that use three primary ink colors—cyan, magenta, and yellow—plus black (abbreviated as CMYK). More recently, printing materials having five or more color (“high fidelity”) have been introduced to provide a larger and more vibrant color gamut. An exemplary set of high fidelity printing materials is Pantone's Hexachrome system, which adds orange and green to the traditional CMYK.

Color printing can also use “spot color” inks alone or in combination with one of the above described printing methods. Spot color inks are specific color formulations that are printed alone, rather than mixed to produce various hues and shades. The range of available spot color inks is nearly unlimited. Spot color inks can be used to print colors from subtle pastels to fluorescent greens and oranges to metallic silvers, golds and other finishes.

Unlike 4 color printing, high fidelity printing does not have a set of colors that dominates the printing industry. High fidelity color gamut extension is most commonly achieved via the use of Cyan-Magenta-Yellow-Black-Orange-Green (CMYKOG printing materials. However, numerous other options are available to satisfy requirements for diverse print jobs, such as Cyan-Light Cyan-Magenta-Light Magenta-Yellow-Black (CcMmYK), Cyan-Light Cyan-Magenta-Pink-Yellow-Black (CcMPYK), Cyan-Magenta-Yellow-Black-Orange-Violet (CMYKOV), and Cyan-Magenta-Yellow-Black-Orange-Blue (CMYKOB) printing materials.

For print shops that desire to offer differentiated high quality color, understanding the potential of and differences between each of these printing materials is critical. In particular, a print provider that offers more than one high fidelity printing option would be required to understand the differences between the color gamuts for each set of printing materials in order to achieve the highest document quality for its customers. Different print jobs can have characteristics that take advantage of the extended color gamuts of one or more high fidelity printing materials, but not others.

Currently, Red-Green-Blue (RGB), L*a*b* and spot color definitions can be converted to a user-selected high fidelity color gamut (typically having between 5 and 7 inks) using color profiles. The task of determining which printing materials should be used for a particular print job currently resides with the print shop operator.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “print job” is a reference to one or more print jobs and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a method of selecting printing materials may include receiving one or more performance criteria, at least one of which is used to measure a capability for a plurality of sets of printing materials, receiving a print job, evaluating, by a computing device, the print job with respect to the one or more performance criteria to produce evaluation information, selecting a first set of printing materials from the plurality of sets of printing materials based on the evaluation information, and providing an indication of the first set of printing materials.

In an embodiment, a system for selecting printing materials may include a processor, and a processor readable storage medium in communication with the processor. The processor readable storage medium may contain one or more programming instructions for receiving, by the processor, one or more performance criteria used to measure a capability of one or more sets of printing materials, receiving a print job, evaluating, by the processor, the print job with respect to the one or more performance criteria to produce evaluation information, and selecting a recommended set of printing materials from the one or more sets of printing materials based on the evaluation information.

In an embodiment, a method of selecting printing materials may include receiving a plurality of absolute preference criteria and a plurality of relative preference criteria used to measure a capability for a plurality of sets of printing materials, receiving a print job, evaluating, by a computing device, the print job with respect to a first absolute preference criterion having a highest precedence to produce first evaluation information, evaluating, by the computing device, the print job with respect to the relative preference criteria to produce second evaluation information, selecting a first set of printing materials from the plurality of sets of printing materials based on the first evaluation information and the second evaluation information, and providing an indication of the first set of printing materials.

### BRIEF DESCRIPTION OF THE DRAWINGS

Aspects, features, benefits and advantages of the present invention will be apparent with regard to the following description and accompanying drawings, of which:

FIG. 1 depicts a flow diagram for an exemplary method of selecting printing materials according to an embodiment.

FIG. 2 depicts a block diagram of an exemplary system that may be used to contain or implement program instructions for selecting printing materials according to an embodiment.

### DETAILED DESCRIPTION

The following terms shall have, for the purposes of this application, the respective meanings set forth below.

A “job” refers to a logical unit of work that is to be completed for a customer. A job may include one or more print jobs from one or more customers. A production system may include a plurality of jobs. Although the disclosed embodiments pertain to a print shop and printing devices, the disclosed methods and systems can be applied to production systems in general.

A “print job” refers to a job processed in a print shop or other document production system. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “printing device” refers to an electronic device that is capable of receiving commands, printing text, vector graphics and/or images on a substrate and/or scanning a document. Print devices may include, but are not limited to, network printers, production printers, copiers, facsimile machines and/or other devices using ink or toner.

“Printing materials” refer to a set of inks or toners available to a printing device for printing a print job. Exemplary printing materials include CMYK, Red-Green-Blue (RGB), Cyan-Magenta-Yellow-Black-Orange (CMYKO). CMYKOG, CeMmYK, CcMPYK, CMYKOV, CMYKOB, CMYK/RGB and the like. “High fidelity printing materials” refer to a set of inks or loners having more than 4 colors, such as CMYKO.

A “gamut” or “color gamut” refers to a complete subset of colors that can be produced by a printing device or via a display device. A gamut or color gamut can alternately refer to a complete subset of colors that are present in a print Job or a portion of a print job, such as a section, a page, an object or the like.

A “color profile” refers to a relationship between a color space and a well known standard. A color profile may be used to transform a color space for a print job, printing device (based on particular printing materials) or display device into, for example, a standardized color space, or vice versa. A color profile may include a “source color profile” (which translates a color space to a standardized color space), a “destination color profile” (which translates the standardized color space to the color space) or both. In an embodiment, the standardized color space may be the color space defined by the International Color Consortium (ICC).

“Out-of-gamut” refers to a condition in which a color in a print job cannot be accurately represented using a printing device or an available set of printing materials, that is, the color falls outside the subset of colors that the printing device or the printing materials can produce.

“Color transformation” refers to the process of translating a print job (or a portion thereof) that is represented in an input color space to an output. In conventional systems, a color transformation converts each input color space for a print job, on a color by color basis, into an output color space using mathematical algorithms represented by two color profiles: the first color profile converts an input color space to a standardized color space, and the second color profile converts the standardized color space to an output color space. The mathematical algorithms of the color profiles for a color transformation may be convolved to produce a single mathematical algorithm to increase efficiency.

The present disclosure describes methods and systems for aiding print shops in determining which printing materials selected from a plurality of available printing materials, including high fidelity printing materials, are best suited for printing a particular print job. The color space for the print job is evaluated using color profiles for the plurality of printing materials. As a result, a determination as to which printing materials would yield the most beneficial aggregate rendering may be made. The performance criteria used to determine the most beneficial printing materials may be defined by each print shop based on, for example, the types of print jobs that it tends to receive.

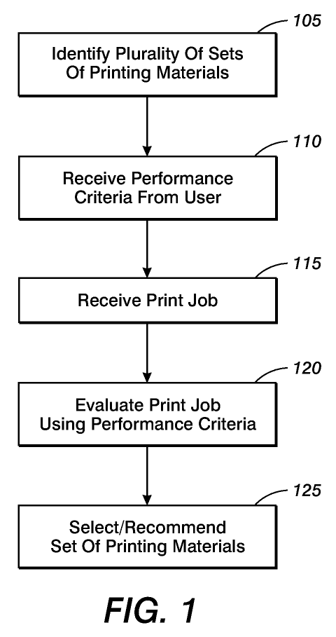

FIG. 1 depicts a flow diagram for an exemplary method of selecting printing materials according to an embodiment. As shown in FIG. 1, a plurality of printing materials may be identified 105. In an embodiment, a user may identify 105 a plurality of printing materials used at a particular print shop and select such printing materials from a list of printing materials that can be evaluated. For example, a user may identify 105 CMYKO+ printing materials (i.e., CMYKOG, CMYKOV and CMYKOB) because such printing materials are used by a print shop while excluding other potential printing materials, such as CcMmYK, which are not used by the print shop. In an alternate embodiment, a user may identify 105 printing materials in order to evaluate whether alternate printing materials improve the quality of work product generated for particular types ofprint jobs as compared with the printing materials currently used by a print shop.

In an embodiment, a user may identify 105 printing materials by providing one or more criteria, rather than identifying particular sets of printing materials individually. In an alternate embodiment, a user may identify 105 all available sets of printing materials. Other methods of identifying 105 printing materials for evaluation may be performed within the scope of this disclosure.

Each set of printing materials may have a corresponding color gamut. The color gamut for a set of printing materials may represent the complete subset of colors that are producible using the printing materials.

One or more performance criteria may be received 110 from the user. A performance criterion may be used to measure a capability of the identified printing materials. Evaluating the performance criteria may result in a recommendation of particular printing materials for use in producing a particular print job.

In an embodiment, one or more of the received performance criteria may be defined as absolute preference criteria, which are evaluated in a known order. For example, one performance criterion may be evaluated to determine a set of identified printing materials that enables production of a print job with the smallest number of out-of-gamut spot colors. An alternate performance criterion may be evaluated to determine a set of identified printing materials that enables production of a print job with the smallest ΔE deviation from the color gamut associated with the printing materials for any spot color. ΔE is a known color difference measure. Additional or alternate difference measures may also be used within the scope of this disclosure.

In an alternate embodiment, the performance criteria may be defined as relative preferences with a weighting factor defined for and applied to each performance criteria. For example, the two performance criteria described above may be considered in combination when determining whether printing materials are suitable for a particular print job. Each performance criterion may be assigned a weighting factor that determines the relative importance of the performance criterion.

Defining the relative importance of performance criteria may be performed at various levels of granularity. For example, a user may define a specific weight to be applied to the outcome of the evaluation of a performance criterion. Alternately, a user interface widget, such as a set of slider bars, may be used to assign a relative importance to each performance criterion. In an embodiment, a user interface widget may correspond to a particular performance criterion.

Alternate performance criteria, such as a relative cost for printing a print job using particular printing materials, an availability of a resource used for particular printing materials, or the like, may additionally or alternately be used within the scope of the present disclosure.

A print job may be received 115. In an embodiment, one or more colors may be identified for the received print job. The one or more colors may represent the input color space for the received print job.

The print job may be evaluated 120 with respect to the one or more performance criteria. If one or more absolute preference criteria are used, such absolute preference criteria may be evaluated 120 in order of precedence. For example, an absolute preference criterion having the highest precedence, such as, for example, the number of out-of-gamut colors for spot colors in the print job, may be evaluated 120 first. The evaluation of the absolute preference criterion having the highest precedence may be performed for each set of identified printing materials. In an embodiment, the set of identified printing materials having the smallest number of out-of-gamut spot colors may be selected or recommended 125. In an alternate embodiment, if the identified sets of printing materials each have a number of out-of-gamut spot colors greater than a threshold value, an absolute preference criterion having a next highest precedence, if any, may be evaluated 120. In an alternate embodiment, if the difference between the number of out-of-gamut spot colors for the set of printing materials having the smallest number of out-of-gamut spot colors and the set of printing materials having the next smallest number of out-of-gamut spot colors is less than a threshold value, an absolute preference criterion having a next highest precedence may be evaluated 120. Evaluation of absolute preference criteria in order of precedence may be performed until a set of identified printing materials satisfies an absolute preference criterion and/or a threshold comparison with respect to an absolute preference criterion (i.e., a set of printing materials is selected or recommended 125).

If no absolute preference criteria are used for the evaluation 120 or no printing materials satisfy an absolute preference criterion or a threshold comparison with respect to an absolute preference criterion, relative preference criteria may be evaluated to select or recommend 125 printing materials. In an embodiment, a default score may be assigned to each set of identified printing materials. The score for each set of printing materials may be modified as a result of the evaluation 120 of the sets of printing materials with respect to the relative preference criteria. Each performance criterion may be evaluated 120 based on the condition that defines the performance criterion.

For example, if the aggregate out-of-gamut disparity is to be evaluated, a color deviation for each color and the area coverage for the corresponding color may be used to determine a size of one or more areas of the print job that are out-of-gamut and the amount by which such areas are out-of-gamut. In an embodiment, the color deviation may be measured using ΔE. When the conditions (e.g., the colors that are misrepresented, the ΔE for each misrepresented color and the area covered by each misrepresented color) are determined, an intermediate value may be assigned to the conditions that may be used to modify the score associated with the corresponding printing materials. The intermediate value may be modified based on the relative importance of the overall performance criteria. For example, aggregate out-of-gamut disparity, which may include, for example, images, may influence the final score proportionately less than the out-of-gamut disparity of large vector objects, which may include, for example, logo colors.

When the applicable performance criteria have been evaluated 120, the final scores for each set of printing materials may be used to select or recommend 125 one or more sets of printing materials. A difference threshold may be used to determine whether one or more of the sets of printing materials may be selected or recommended 125. In an embodiment, an indication of the one or more sets of selected printing materials, such as a description of selected printing materials or a list of colors for selected printing materials, may be provided.

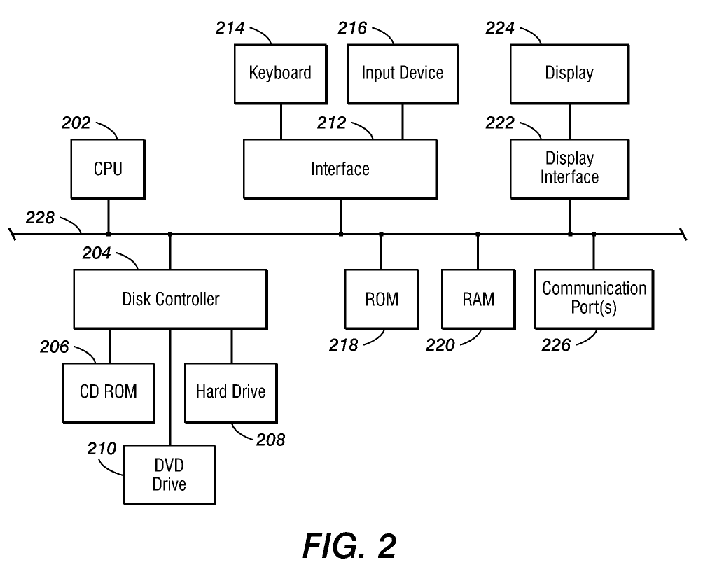

FIG. 2 depicts a block diagram of an exemplary system that may be used to contain or implement program instructions for selecting printing materials according to an embodiment. Referring to FIG. 2, a bus 228 serves as the main information highway intercoimecting the other illustrated components of the hardware. CPU 202 is the central processing unit of the system, performing calculations and logic operations required to execute a program. Read only memory (ROM) 218 and random access memory (RAM) 220 constitute exemplary memory devices or storage media.

A disk controller 204 interfaces with one or more optional disk drives to the system bus 228. These disk drives may include, for example, external or internal DVD drives 210, CD ROM drives 206 or hard drives 208. As indicated previously, these various disk drives and disk controllers are optional devices.

Program instructions may be stored in the ROM 218 and/or the RAM 220. Optionally, program instructions may be stored on any other tangible computer readable storage medium, such as a hard drive, a compact disk, a digital disk, a memory or any other tangible recording medium.

An optional display interface 222 may permit information from the bus 228 to be displayed on the display 224 in audio, graphic or alphanumeric format. Communication with external devices may occur using various communication ports 226.

In addition to the standard computer-type components, the hardware may also include an interface 212 which allows for receipt of data from input devices such as a keyboard 214 or other input device 216 such as a mouse, remote control, pointer and/or joystick.

An embedded system may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method of selecting printing materials, the method comprising:
receiving one or more performance criteria, wherein at least one performance criterion is used to measure a capability for a plurality of sets of printing materials;
receiving a print job;
evaluating, by a computing device, the print job with respect to the one or more performance criteria to produce evaluation information;
selecting a first set of printing materials from the plurality of sets of printing materials based on the evaluation information; and
providing an indication of the first set of printing materials.

2. The method of claim 1 wherein:
receiving one or more performance criteria comprises receiving one or more absolute preference criteria, and
evaluating the print job comprises evaluating, by the computing device, the print job with respect to a first absolute preference criterion to produce evaluation information, wherein the first absolute preference criterion has a highest precedence.

3. The method of claim 2 wherein evaluating the print job further comprises:
evaluating, by the computing device, the print job with respect to a second absolute preference criterion to produce evaluation information, wherein the second absolute preference criterion has a lower precedence than the first absolute preference criterion.

4. The method of claim 1 wherein:
receiving one or more performance criteria comprises receiving relative preference criteria; and
evaluating the print Job comprises evaluating, by the computing device, the print job with respect to the relative preference criteria to produce evaluation information.

5. The method of claim 1 wherein evaluating the print job with respect to the one or more performance criteria comprises:
determining a number of out-of-gamut spot colors.

6. The method of claim 1 wherein evaluating the print job with respect to the one or more performance criteria comprises:
determining a smallest color difference between a rendered spot color and an ideal spot color.

7. The method of claim 1 wherein evaluating the print job with respect to the one or more performance criteria comprises:
for at least one set of printing materials determining whether the set of printing materials satisfies a first performance criteria for the print job; and
selecting a set of printing materials that satisfies the first performance criteria.

8. The method of claim 1 wherein evaluating the print job with respect to the one or more performance criteria comprises, for at least one performance criteria:
determining one or more intermediate scores;
for at least one intermediate score, assigning a weight to the intermediate score; and
determining a final score based on at least the weighted intermediate scores.

9. The method of claim 1, further comprising:
providing one or more second sets of printing materials selected from the plurality of sets of printing materials, wherein a final score for each second set of printing materials is within a difference threshold of a final score for the first set of printing materials.

10. A system for selecting printing materials, the system comprising:
a processor; and
a processor readable storage medium in communication with the processor,
wherein the processor readable storage medium contains one or more programming instructions for:
receiving, by the processor, one or more performance criteria used to measure a capability of one or more sets of printing materials,
receiving a print job,
evaluating, by the processor, the print job with respect to the one or more performance criteria to produce evaluation information, and
selecting a recommended set of printing materials from the one or more sets of printing materials based on the evaluation information.

11. The system of claim 10 wherein:
the one or more programming instructions for receiving one or more performance criteria comprises one or more programming instructions for receiving one or more absolute preference criteria; and
the one or more programming instructions for evaluating the print job comprises one or more programming instructions for evaluating, by the computing device, the print job with respect to a first absolute preference criterion to produce evaluation information, wherein the first absolute preference criterion has a highest precedence.

12. The system of claim 11 wherein the one or more programming instructions for evaluating the print job further comprise one or more programming instructions for evaluating, by the computing device, the print job with respect to a second absolute preference criterion to produce evaluation information, wherein the second absolute preference criterion has a lower precedence than the first absolute preference criterion.

13. The system of claim 10 wherein:
the one or more programming instructions for receiving one or more performance criteria comprise one or more programming instructions for receiving relative preference criteria; and
the one or more programming instructions for evaluating the print job comprise one or more programming instructions for evaluating, by the computing device, the print job with respect to the relative preference criteria to produce evaluation information.

14. The system of claim 10 wherein the one or more programming instructions for evaluating the print job with respect to the one or more performance criteria comprises one or more programming instructions for;
determining a number of out-of-gamut spot colors.

15. The system of claim 10 wherein the one or more programming instructions for evaluating the print job with respect to the one or more performance criteria comprises one or more programming instructions for:
determining a smallest color difference between a rendered spot color and an ideal spot color.

16. The system of claim 10 wherein the one or more programming instructions for evaluating the print job with respect to the one or more performance criteria comprise one or more programming instructions for:
for at least one set of printing materials, determining whether a first performance criteria is satisfied for the print job by the set of printing materials;
selecting a set of printing materials that satisfies the first performance criteria.

17. The system of claim 10 wherein the one or more programming instructions for evaluating the print job with respect to the one or more performance criteria comprise one or more programming instructions for:
determining an intermediate score for a plurality of performance criteria;
for each intermediate score, assigning a weight to the intermediate score, and
determining a final score based on the weighted intermediate scores.

18. The system of claim 10 wherein the one or more programming instructions further comprise one or more programming instructions for:
providing one or more second sets of printing materials selected from the one or more sets of printing materials, wherein a final score for each second set of printing materials is within a difference threshold of a final score for the first set of printing materials.

19. A method of selecting printing materials, the method comprising:
receiving a plurality of absolute preference criteria and a plurality of relative preference criteria, wherein the absolute preference criteria and the relative preference criteria are used to measure a capability for a plurality of sets of printing materials;
receiving a print job;
evaluating, by a computing device, the print job with respect to a first absolute preference criterion to produce first evaluation information, wherein the first absolute preference criterion has a highest precedence;
evaluating, by the computing device, the print job with respect to the relative preference criteria to produce second evaluation information;
selecting a first set of printing materials from the plurality of sets of printing materials based on the first evaluation information and the second evaluation information; and
providing an indication of the first set of printing materials.
